(19) United States
(12) Patent Application Publication
(10) Pub. No.: US 2026/0107164 A1
(43) Pub. Date: Apr. 16, 2026

(54) METHOD OF GENERATING PHYSICAL CHANNEL PARAMETERS FOR WIRELESS CHANNELS

(71) Applicants: Rohde & Schwarz GmbH & Co. KG, Muenchen (DE); Technische Universität München, in Vertretung des Freistaates Bayern, München (DE)

(72) Inventors: Timo MAYER, Muenchen (DE); Francesco ROSSETTO, Muenchen (DE); Andreas OELDEMANN, Muenchen (DE); Ramez KHOURY, Muenchen (DE); Andreas ROESSLER, Columbia, MD (US); Syed SADAF, Muenchen (DE); Benedikt BOECK, Muenchen (DE); Wolfgang UTSCHICK, Muenchen (DE)

(21) Appl. No.: 18/912,123

(22) Filed: Oct. 10, 2024

(51) Int. Cl. H04W 24/06; H04L 1/00

(52) U.S. Cl. CPC H04W 24/06; H04L 1/0006; H04L 1/0026

(57) ABSTRACT

A method of generating physical channel parameters for wireless channels is described. The method includes: obtaining measurement data based on wireless channel observations; training a generative model with the measurement data such that the generative model learns statistical properties of physical channel parameters based on the measurement data of the wireless channel observations; and generating physical channel parameters by using the trained generative model.

### FIELD OF THE DISCLOSURE

The present disclosure relates to a method of generating physical channel parameters for wireless channels. In addition, the present disclosure relates to a method of using generated physical channel parameters for providing training data to train machine-learning-based signal processing chains and/or for generating artificial wireless channels for testing devices under test.

### BACKGROUND

Wireless channels, e.g. radio channels, are used for wireless information transfer from a transmitter to a receiver. The respective realization of a wireless channel, namely a wireless channel realization, can be characterized by various physical channel parameters like for example an angle of a radio wave impinging on the receiver or a relative speed between the receiver and the transmitter in case of a relative motion.

In many industrial applications, it is of central interest to have access to a database including realistic physical channel parameters (e.g. angles, delays, etc.) of wireless channel realizations. Possible applications include, for example, testing of wireless devices or training of (machine learning-based) signal processing chains.

The more detailed the information provided by the database is, the better the applications can profit from the database. For example, a database including detailed and realistic physical channel parameters of respective wireless channel realizations can be used for testing a broad spectrum of receiver hardware. In contrast, use of a database with less detailed information, e.g. only channel coefficients (channel realizations), is limited to testing a specific type of receiver hardware.

Conventionally, an extensive measurement campaign is necessary for obtaining a sufficiently large database with detailed and realistic information, namely physical channel parameters of the wireless channel realizations to be used for testing. Such measurement campaigns are associated with large time investments and high costs.

Accordingly, there is a need for a method of generating physical channel parameters that is capable of providing detailed and realistic channel information quickly and in a cost-efficient manner.

### SUMMARY

The following summary of the present disclosure is intended to introduce different concepts in a simplified form that are described in further detail in the detailed description provided below. This summary is neither intended to denote essential features of the present disclosure nor shall this summary be used as an aid in determining the scope of the claimed subject matter.

The present disclosure provides a method of generating physical channel parameters for a wireless channel. In an embodiment, the method comprises: obtaining measurement data based on wireless channel observations; training a generative model with the measurement data such that the generative model learns statistical properties of physical channel parameters based on the measurement data of the wireless channel observations; and generating physical channel parameters by using the trained generative model.

Accordingly, the physical channel parameters can be provided quickly and in a cost-efficient manner. By using the trained generative model, detailed and realistic information in the form of physical channel parameters can be obtained without having to perform an extensive measurement campaign.

In an embodiment, the measurement data may be referred to as a training data set. The method allows learning the statistical characteristics of the physical channel parameters without requiring such physical channel parameters to be present in the training data set. In an embodiment, the training set comprises data obtained from wireless channel observations.

Since the generative model learns the statistical properties of the physical channel parameters, the generative model can be combined with a general system configuration (e.g. other subcarrier spacings, other antenna array geometries etc.) to provide wireless channel observations. The general system configuration can differ from the one used for collecting the wireless channel observations.

In other words, the generative model is not trained for the specific receiver hardware that was used when obtaining the measured channel observations but generalizes to different types of receiver hardware. Consequently, the generative model can be used for providing new channel realizations for different system configurations.

In general, a system configuration relates to aspects of the measurement device. Hence, a system configuration may comprise the number of receiving antennas and transmitting antennas as well as the respective geometry of a receiving antenna array and/or a transmitting antenna array. It may also comprise the sampling frequency in the channel's delay domain, which corresponds to the bandwidth in the frequency domain considering the Fourier transform. Moreover, it may also comprise the number of samples taken in the delay domain and, thus, the measurement duration in the delay domain, which corresponds to the subcarrier spacing in the frequency domain considering the Fourier transform. Additionally, it may comprise the sampling frequency and number of samples in the time domain.

The wireless channel relates to a random variable/vector/matrix/tensor, which describes a mapping from the transmitted signal to the received signal under a certain system configuration.

A wireless channel realization is one specific realization of the wireless channel as defined above. In other words, it is one sample drawn from the associated probability distribution with the wireless channel. A wireless channel realization is typically representative by a complex valued number/vector/matrix/tensor.

A wireless channel observation is a potentially noisy and compressed observation of a wireless channel realization as defined above, i.e. it contains information about a specific wireless channel realization, but potentially has been compressed/corrupted. For instance, measurement specific noise or compression may have an impact.

The physical channel parameters comprise parameters that characterize a wireless channel realization as defined above. In an embodiment, the physical channel parameters comprise parameters like angles, delays, Dopplers, complex valued path losses and number of paths (of a specific wireless channel realization). The corresponding wireless channel realization is a highly nonlinear function of the physical channel parameters.

Channel coefficients relate to entries of a corresponding wireless channel realization as the wireless channel realization typically consists of individual entries referred to as the channel coefficients.

Consequently, the main idea of the present disclosure aims to employ a generative model that is trained by wireless channel observations in order to learn statistical properties of physical channel parameters. In other words, the statistical properties are learned without inputting the physical channel parameters themselves during the training. Nevertheless, the trained generative model is enabled to output physical channel parameters.

In an embodiment, the wireless channel observations may be compressed and/or comprise noise. For example, the measurement data can comprise channel observations measured by a base station during online operation. A particular benefit of the method is that statistical characteristics of the physical channel parameters can be learned based on channel observations that are compressed and/or comprise noise. Examples of the method can thus generate physical channel parameters whilst relying solely on noisy and/or compressed channel observations.

A specific measurement instrument, related to a specific system configuration, may be used for obtaining the measurement data. In an embodiment, the measurement instrument may be, for example, a wireless communication tester. As another option, a base station may be used as the measurement instrument. Whilst the channel observations relate to the specific system configuration, the learned statistical properties of the physical parameters are not limited to the specific system configuration.

The measurement data can be based on wireless channel observations of different wireless channel realizations. As already defined above, the wireless channel can be described as a random variable (or random vector, random matrix, or random tensor) providing a mapping from a transmitted signal to a received signal. The channel realizations may be seen as specific realizations of the wireless channel (e.g. realizations of the random variable representing the wireless channel).

In an embodiment, the measurement data may comprise digital in-phase and quadrature (I/Q) data. I/Q data is to be understood as information about how to amplitude-modulate in-phase and quadrature phases of a sine wave.

In one or more embodiments, the physical channel parameters may comprise at least one of: angle of arrival, path loss, complex path loss, Doppler shifts, delays, or number of paths. Herein, angle of arrival can be understood as an angle (or direction) from which a signal is received (i.e. the impinging angle). Path loss can be understood as a reduction in power density of a signal. The Doppler shifts relate to a movement speed of a receiver relative to a transmitter. A delay can be understood as a propagation delay of a signal travelling on a specific path from a transmitter to a receiver.

In an embodiment, the physical channel parameters can comprise physically interpretable parameters that characterize a wireless channel realization. The corresponding channel realization is a (highly) nonlinear function of the physical channel parameters. The physical channel parameters take the given propagation scenario into account and may be used to describe a wireless channel realization completely.

According to one aspect of the present disclosure, the physical channel parameters, for example, may be used for generating at least one new wireless channel realization. The at least one new wireless channel realization may relate to a system configuration different from the system configuration that was used for collecting the wireless channel observations. Accordingly, new channel realizations can be generated based on characteristics of a device under test (DUT) that differs from the measurement instrument used for obtaining the measurement data. Hence, channel realizations concerning the DUT can be provided without having to perform additional measurements involving the DUT. Time and costs can thus be saved.

At least one system configuration may be selected and applied to the physical channel parameters for generating the at least one new wireless channel realization. Hence, it is possible to generate a wireless channel realization relating to the selected system configuration. The system configuration is also referred to as a dictionary and may be expressed as a matrix comprising steering vectors. A weighted sum of the steering vectors can be used to express the wireless channel.

In an embodiment, the new wireless channel coefficients can be obtained when generating the at least one new wireless channel realization. The channel coefficients are the entries of the wireless channel realization. For example, if the wireless channel realization is expressed as a vector, the channel coefficients are the entries of the vector.

In an embodiment, the new wireless channel coefficients may comprise a plurality of sampled values over at least one of the frequency domain, the time domain, or the spatial domain. A matrix representation that allows combining domains may be chosen for the dictionary that relates to the system configuration. Hence, a dictionary matrix can be created for a combination of domains, e.g. for a combination of the time domain and the spatial domain.

In an embodiment, the at least one new wireless channel realization may be generated without retraining the generative model. More specifically, it is not necessary to retrain the generative model with respect to a system configuration differing from the system configuration used for collecting the channel observations.

For example, no retraining is required for generating new channel realizations based on characteristics of a DUT that differs from the measurement instrument used for collecting the channel observations. The method can thus be adapted to various DUTs in a time-efficient and economical manner. Hence, the trained generative model is ideally suited for generating channel realizations associated with different receiver hardware.

In an embodiment, the at least one new wireless channel realization can be physically consistent. For example, the new wireless channel realizations can be consistent with the physical properties described by the generated physical channel parameters. Further, generated channel realizations may fulfill the wide-sense stationary uncorrelated scattering (WSSUS) property of wireless channels.

In general, the compressibility of the measurement data with respect to the physical parameter domain may be exploited for training the generative model. To obtain the measurement data, a compressive measurement can be performed. Compressive measurements yield measurement data from which most or all the useful information of a measured signal can be reconstructed. Accordingly, detailed information can be obtained even when the number of samples (in the form of compressive measurements) is limited.

In an embodiment, the generative model may be a parametrized statistical model from which the physical channel parameters are generated. By using a statistical model, physical channel parameters can be generated with limited computational resources and without requiring detailed prior information about the propagation scenario.

In an embodiment, the generative model may be based on a conditional Gaussian distribution. In this regard, a compressed representation of a signal can be defined as a variable having a conditional Gaussian distribution, conditional on an arbitrary latent random variable and equipped with an arbitrarily parameterized diagonal covariance matrix.

For example, the generative model can be built upon a Gaussian mixture model (GMM), a variational autoencoder (VAE), or a diffusion model. These approaches have in common that input data is represented in a latent space. While GMMs use a discrete latent space, VAEs may provide greater flexibility due to their use of a continuous latent space.

In an embodiment, the generative model may parameterize a compressible representation of a wireless channel in its parameter domain to be a conditional Gaussian distribution with a mean of zero and a diagonal covariance matrix. This conditional Gaussian distribution can be assigned to the compressible representation of the wireless channel.

In general, the generative model may be trained to learn the statistical properties of the physical channel parameters of the wireless channel based on (solely) noisy, compressed, and raw measurement data. The generative model, when trained, is enabled to generate physical parameters, which may be used for describing a wireless channel completely. In other words, physically consistent wireless channels may be provided.

Example embodiments of the method can be understood as incorporating compressive sensing in generative modeling and substantially decreases the requirements on the training data set (in terms of quality and level of detail). This is particularly relevant in wireless communication as it is very difficult to obtain a large amount of high-resolution and low-noise measurement data sets describing wireless channels.

In an embodiment, the trained generative model may be used by a channel emulator (for emulating wireless channels), a signal generator (for generating a signal used for testing), a mobile radio tester, or a mobile network tester.

According to another aspect, the generated physical channel parameters, for example, may be sold to a customer, thus enabling the customer to perform testing of wireless channels based on the acquired physical channel parameters.

In addition, the present disclosure provides a method of using the physical channel parameters generated by the method described herein. The generated physical channel parameters are used, for example, for providing training data to train machine-learning-based signal processing chains and/or for generating artificial wireless channels for testing devices under test. Features and advantages described above with regard to the method of generating physical channel parameters apply analogously to the method of using the generated physical channel parameters.

### DESCRIPTION OF THE DRAWINGS

The foregoing aspects and many of the attendant advantages of the claimed subject matter will become more readily appreciated as the same become better understood by reference to the following detailed description, when taken in conjunction with the accompanying drawings, wherein:

FIG. 1 is a representative flow chart schematically illustrating a method of generating physical channel parameters for wireless channels according to an aspect of the present disclosure; and

FIG. 2 is a representative block diagram schematically illustrating the steps of training a generative model and generating physical channel parameters, respectively, according to an aspect of the present disclosure.

### DETAILED DESCRIPTION

The detailed description set forth below in connection with the appended drawings, where like numerals reference like elements, is intended as a description of various embodiments of the disclosed subject matter and is not intended to represent the only embodiments. Each embodiment described in this disclosure is provided merely as an example or illustration and should not be construed as preferred or advantageous over other embodiments. The illustrative examples provided herein are not intended to be exhaustive or to limit the claimed subject matter to the precise forms disclosed.

In the context of the present disclosure, a wireless channel describes the mapping from a transmitted signal to a received signal under a certain system configuration. The system configuration depends on aspects of the used measurement instrument. For example, the system configuration can comprise the number of receiving antennas and transmitting antennas, the receiving and/or transmitting antenna array geometry, the sampling frequency in the channel's delay domain (i.e., the frequency bandwidth used for the measurements). The system configuration can further comprise the number of samples in the channel's delay domain and thus the overall measurement duration in the delay domain (i.e., the distance of adjacent subcarriers). Moreover, the system configuration can comprise the sampling frequency and the number of samples in the channel's time domain.

In the context of the present disclosure, a wireless channel is considered as a random variable, random vector, random matrix, or random tensor. Which representation is most suitable may depend on the given system configuration.

A specific realization of the wireless channel (e.g. of the random variable) is referred to as a channel realization. It can be considered as one sample drawn from the probability distribution associated with the wireless channel.

A channel realization can be represented by a complex-valued number, vector, matrix, or tensor. The entries of a channel realization are referred to as channel coefficients. For example, the individual entries of a (complex-valued) matrix representing the channel realization are referred to as channel coefficients.

A potentially noisy and/or compressed observation of a channel realization is referred to as a channel observation. Accordingly, a channel observation contains information about a specific channel realization but has potentially been corrupted (e.g. by measurement-specific noise) and/or compressed (e.g. by a compressive measurement).

A channel realization can be characterized by physically interpretable parameters like e.g. angles, delays, Doppler shifts, complex-valued path losses, and number of paths (of the specific channel realization). In the context of the present disclosure, such parameters are referred to as physical channel parameters. The corresponding channel realization is a highly nonlinear function of the physical channel parameters.

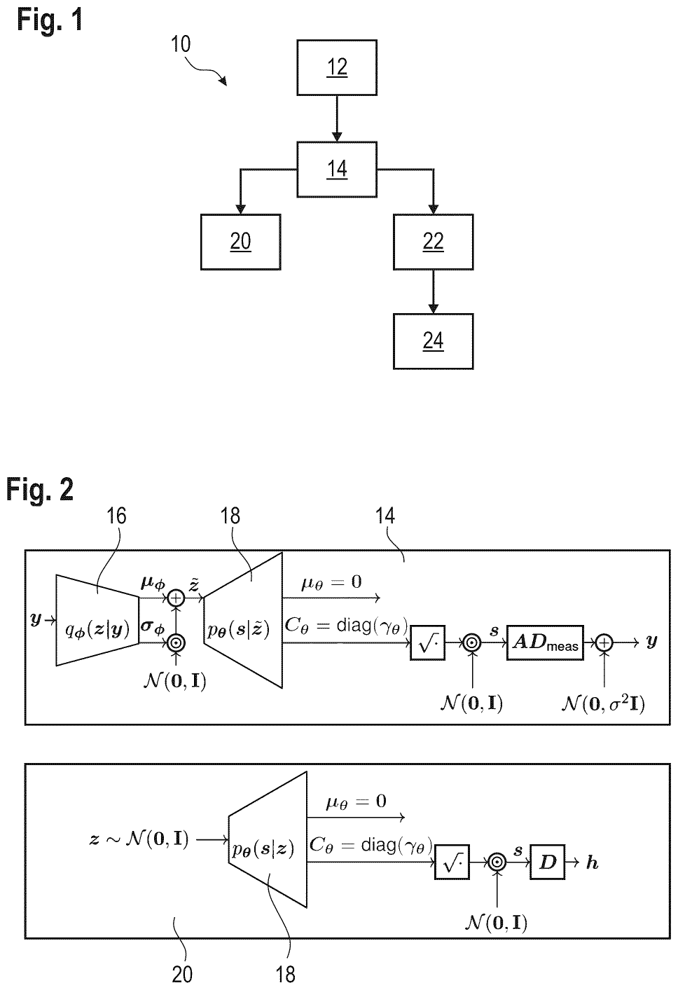

FIG. 1 is a representative flow chart that schematically illustrates a method of generating physical channel parameters for wireless channels according to an aspect of the present disclosure. The method 10 comprises, in a first step represented by block 12, the step of obtaining measurement data based on wireless channel observations.

The measurement data may be obtained, for example, by using a measurement instrument connected to a plurality of antennas so as to collect channel observations of wireless channels used by a receiver and a transmitter, namely the measurement instrument and a device. The measurement instrument may relate to the receiver that receives a radio frequency signal from the device via the wireless channel, e.g. a radio channel.

In an embodiment, the measurement data may be processed data. For example, the measurement data may comprise digital I/Q data. However, the measurement data may also relate to raw data, namely data that is not (pre-) processed.

The method 10 further comprises, in a second step represented by a block 14, the step of training a generative model with the measurement data such that the generative model learns statistical properties of physical channel parameters based on the measurement data of the wireless channel observations.

For understanding the training approach according to the present disclosure, reference is made to the method of sparse Bayesian learning (SBL) which is used for reconstructing compressed and/or noisy signals. Hence, the measurement data may relate to data obtained from a compressed and/or noisy (radio frequency) signal.

Within SBL, it is assumed that the signal x* to be reconstructed is compressible with regard to a set D of given basis vectors. The set D is also called a dictionary. A Gaussian distribution (normal distribution) with a diagonal covariance matrix and the mean (expectancy value) set to zero is assigned to the compressed representation s of x*.

Measurements y of the specific signal x* are compressed due to a compressive (compressing) measurement operation A and can include noise. In particular, the signal x* is a signal that is compressible in a corresponding physical parameter domain.

A Gaussian distribution conditional on s, with a mean (expectancy value) of ADs and a scaled unity matrix as a covariance matrix, is assigned to the measurements y. The above can be summarized with the following relations:

$$y \vert s ∼ 𝒩 ( ADs , {σ}^{2} I )$$

$$s ∼ {p}_{γ} ( s ) = 𝒩 ( s ; 0 , diag ( γ ) ) .$$

Going beyond SBL, according an aspect of to the present disclosure the random vector s is defined to be a conditionally Gaussian distributed variable, conditional on an arbitrary latent random variable z and equipped with an arbitrarily parameterized diagonal covariance matrix diag(γ_{θ}(z)). This can also be expressed as follows:

$$y \vert s ∼ p ( y \vert s ) = 𝒩 ( y ; ADs , {σ}^{2} I )$$

$$s \vert z ∼ {p}_{θ} ( s \vert z ) = 𝒩 ( s ; 0 , diag ( {γ}_{θ} ( z ) )$$

$$z ∼ p ( z ) .$$

Therein, a parameter set θ describes the probability distribution of s. The training process according to the present disclosure is based exclusively on a number Nₜ of measured channel observations

$${\{ {y}_{i} \}}_{i = 1}^{{N}_{t}} .$$

In particular, the channel observations are compressed (due to a compressive measurement) and unprocessed, e.g. raw data. Moreover, the channel observations may include noise.

An effect arising from the definitions above is that, given a fixed intermediate state of p(z) and θ, the statistical properties of s|y, z can be determined completely. This is guaranteed by the fact that due to the Gaussian assumption of s|z, this random vector s constitutes a conditional conjugate prior of y. Hence, a sparsity of the measurement data can be exploited for training the generative model. Detailed and accurate information can thus be derived even from a limited amount of measurement data.

The complete statistical characterization is realized, for example, by the conditional expectation of s|y, z and the conditional covariance matrix of s|y, z. More particularly, the conditional expectation of s|y, z is the best estimator of s given y and z in the sense of a quadratic error measure. The conditional covariance matrix of s|y, z is a quantified measure of the uncertainty of the estimation.

The conditional expectation of s|y, z and the conditional covariance matrix of s|y, z are calculable in closed form and can subsequently be used in a next iteration step for an adjustment of p(z) as well as θ. Afterwards, s|y, z can be estimated once more. The objective function being optimized via this process corresponds either to the likelihood function or to a lower bound for the likelihood function, which is based on a variational principle.

Generally, the method 10 according to the present disclosure supports arbitrary configurations of p(z) (e.g. discrete or continuous) and θ, which can influence the concrete training process. For example, the parameter set θ can represent the weights of a neural network, which outputs the conditional covariance matrix diag(γ_{θ}(z)).

Moreover, additional variational parameters Φ (e.g. representative of the weights of an additional neural network) may be introduced, which represent the distribution of z|y.

In an embodiment, the, the method 10 can be formulated to be schematically similar to the encoder-decoder structure of a variational autoencoder (VAE). This can be seen in FIG. 2, which is an example of a block diagram schematically illustrating the steps of training a generative model and generating physical channel parameters, respectively.

In FIG. 2, the step represented by block 14 relates to the training of the generative model with the measurement data. The training is performed by an encoder 16 and a decoder 18.

The step represented by block 20 relates to the step of generating physical channel parameters (for the system configuration with which the measurement data were obtained) by using the trained generative model. For generating the physical channel parameters, only the decoder is relied upon. Details about the purpose of the channel parameter generation are provided further below, again with reference to FIG. 1.

According to another aspect, the method 10, for example, may be formulated to have a training process with a similar structure as a Gaussian mixture model (GMM). Such a formulation is expedient particularly if the distribution p(z) is discrete and a classical parametrization θ is applied. As another alternative, the structure of a diffusion model may be used for the generative model of the method 10.

Referring again to FIG. 1, the method 10 further comprises, in a step represented by block 20, the step of generating physical channel parameters by using the trained generative model. For generating the physical channel parameters, the present disclosure particularly uses the widely accepted assumption that a wireless channel h can be expressed in the spatial, temporal, as well as the frequency domain as a weighted sum of steering vectors. This can be expressed as:

$$h = {\sum }_{n = 1}^{N} {ρ}_{n} {a}_{n} ,$$

Therein, ρₙ corresponds to the complex path loss and αₙ to the steering vector of the n^{th} path. Depending on the domain, the steering vector αₙ encodes the corresponding angle of arrival, the corresponding Doppler shift, or the corresponding delay of the n^{th} path.

Through sampling, for example granular sampling, with M sampling points for the respective domain, it is also possible to express the channel h as:

$$h = D s .$$

Therein, the matrix D (the dictionary) includes all steering vectors at every sampling point of the respective domain as column vectors. The entries sₘ of the vector s are given by:

$${s}_{m} = \{ \begin{matrix}{ρ}_{n} if {a}_{n} = D [ : , m ] \\ otherwise .\end{matrix}$$

Here, D[:,m] corresponds to the m^{th} column of the matrix D. This representation also allows combining domains. Accordingly, a matrix D can be created for the combination of e.g. the spatial and the temporal domain via the Kronecker product of the respective separate D-matrices of the two domains. Resulting from this, the vector s can encode all physical properties of the respective channel h. Hence, the generated physical channel parameters can comprise angle of arrival, path loss, complex path loss, Doppler shifts, delays, and/or number of paths.

In an embodiment, the vector s can encode the number of paths via the number of entries differing from zero and/or the complex-valued path losses via the entries of the vector s. Depending on the choice of domain or combination of domains, the vector s can also encode the angles of arrival, the Doppler shifts and/or the delays of the paths via the indices of the non-zero entries in the vector s.

How a respective channel h is obtained based on the generated vector s can be adapted dynamically via the choice of the matrix D to a receiver hardware of interest. Referring back to FIG. 1, the method 10 may thus comprise, in a step associated with block 22, the step of choosing a matrix D that is adapted to characteristics of a device under test (DUT). Moreover, the method 10 can comprise, in a step represented by block 24, a generation of new channel realizations. More specifically, the adapted matrix D is used for generating the new channel realizations.

Accordingly, the new channel realizations may be generated based on characteristics of a DUT that differs from the measurement instrument used for obtaining the measurement data, as already indicated above.

A new training of the generative model (regarding characteristics of the DUT) is not required. Put differently, by choosing an appropriate matrix D, new channel realizations can be generated for a system configuration different from the system configuration with which the measured parameters were obtained.

After choosing the matrix D, a newly generated channel realization can be represented as follows:

$$h = {\sum }_{m = 1}^{M} {s}_{m} D [ : , m ] = {\sum }_{n = 1}^{N} {ρ}_{n} {a}_{n} .$$

Therefore, the generated channel realization is physically consistent by design. In other words, the trained generative model can be used for defining physically consistent wireless channel realizations. Moreover, the generated channel realizations may fulfill the wide-sense stationary uncorrelated scattering (WSSUS) property of wireless channels.

The method 10 according to the present disclosure, for example the step of training the generative model (block 14) and/or the step of generating physical channel parameters (block 20) can be performed by suitable hardware equipment comprising one or more electronic circuits. Examples of suitable hardware equipment include channel emulators, signal generators, and mobile radio testers.

Certain embodiments disclosed herein include systems, apparatus, modules, units, devices, components, etc., that utilize circuitry (e.g., one or more circuits) in order to implement standards, protocols, methodologies or technologies disclosed herein, operably couple two or more components, generate information, process information, analyze information, generate signals, encode/decode signals, convert signals, transmit and/or receive signals, control other devices, etc. Circuitry of any type can be used. It will be appreciated that the term “information” can be use synonymously with the term “signals” in this paragraph. It will be further appreciated that the terms “circuitry,” “circuit,” “one or more circuits,” etc., can be used synonymously herein.

In an embodiment, circuitry includes, among other things, one or more computing devices such as a processor (e.g., a microprocessor), a central processing unit (CPU), a graphics processing unit (GPU), a digital signal processor (DSP), an application-specific integrated circuit (ASIC), a field programmable gate array (FPGA), a system on a chip (SoC), or the like, or any combinations thereof, and can include discrete digital or analog circuit elements or electronics, or combinations thereof. In an embodiment, circuitry includes hardware circuit implementations (e.g., implementations in analog circuitry, implementations in digital circuitry, and the like, and combinations thereof).

In an embodiment, circuitry includes combinations of circuits and computer program products having software or firmware instructions stored on one or more computer readable memories that work together to cause a device to perform one or more protocols, methodologies or technologies described herein. In an embodiment, circuitry includes circuits, such as, for example, microprocessors or portions of microprocessor, that require software, firmware, and the like for operation. In an embodiment, circuitry includes an implementation comprising one or more processors or portions thereof and accompanying software, firmware, hardware, and the like.

For example, the functionality described herein can be implemented by special purpose hardware-based computer systems or circuits, etc., or combinations of special purpose hardware and computer instructions. Each of these special purpose hardware-based computer systems or circuits, etc., or combinations of special purpose hardware circuits and computer instructions form specifically configured circuits, machines, apparatus, devices, etc., capable of implementing the functionality described herein.

Of course, in an embodiment, two or more of these components, or parts thereof, can be integrated or share hardware and/or software, circuitry, etc. In an embodiment, these components, or parts thereof, may be grouped in a single location or distributed over a wide area. In circumstances where the components are distributed, the components are accessible to each other via communication links.

In an embodiment, circuitry is provided that is programmed to carry out one or more steps of any of the methods disclosed herein. In an embodiment, one or more computer-readable media associated with or accessible by such circuitry contains computer readable instructions embodied thereon that, when executed by such circuitry, cause the component or circuitry to perform one or more steps of any of the methods disclosed herein.

In an embodiment, the computer readable instructions includes applications, programs, program modules, scripts, source code, program code, object code, byte code, compiled code, interpreted code, machine code, executable instructions, and/or the like (also referred to herein as executable instructions, instructions for execution, program code, computer program instructions, and/or similar terms used herein interchangeably).

In an embodiment, computer-readable media is any medium that stores computer readable instructions, or other information non-transitorily and is directly or indirectly accessible by a computing device, such as processor circuitry, etc., or other circuitry disclosed herein etc. In other words, a computer-readable medium is a non-transitory memory at which one or more computing devices can access instructions, codes, data, or other information. As a non-limiting example, a computer-readable medium may include a volatile random access memory (RAM), a persistent data store such as a hard disk drive or a solid-state drive, or a combination thereof. In an embodiment, memory can be integrated with a processor, separate from a processor, or external to a computing system.

Accordingly, blocks of the block diagrams and/or flowchart illustrations support various combinations for performing the specified functions, combinations of operations for performing the specified functions and program instructions for performing the specified functions. These computer program instructions may be loaded onto one or more computer or computing devices, such as special purpose computer(s) or computing device(s) or other programmable data processing apparatus(es) to produce a specifically-configured machine, such that the instructions which execute on one or more computer or computing devices or other programmable data processing apparatus implement the functions specified in the flowchart block or blocks and/or carry out the methods described herein. Again, it should also be understood that each block of the block diagrams and flowchart illustrations, and combinations of blocks in the block diagrams and/or flowchart illustrations, or portions thereof, could be implemented by special purpose hardware-based computer systems or circuits, etc., that perform the specified functions or operations, or combinations of special purpose hardware and computer instructions.

It will be appreciated that in one or more embodiments, the term computer or computing device can include, for example, any computing device or processing structure, including but not limited to a processor (e.g., a microprocessor), a central processing unit (CPU), a digital signal processor (DSP), an application-specific integrated circuit (ASIC), a field-programmable gate array (FPGA), a system on a chip (SoC), a graphics processing unit (GPU) or the like, or any combinations thereof.

In the foregoing description, specific details are set forth to provide a thorough understanding of representative embodiments of the present disclosure. It will be apparent to one skilled in the art, however, that the embodiments disclosed herein may be practiced without embodying all of the specific details. In some instances, well-known process steps have not been described in detail in order not to unnecessarily obscure various aspects of the present disclosure.

Although the method and various embodiments thereof have been described as performing sequential steps, the claimed subject matter is not intended to be so limited. As nonlimiting examples, the described steps need not be performed in the described sequence and/or not all steps are required to perform the method. Moreover, embodiments are contemplated in which various steps are performed in parallel, in series, and/or a combination thereof. As such, one of ordinary skill will appreciate that such examples are within the scope of the claimed embodiments.

In the detailed description herein, references to “one embodiment”, “an embodiment”, “an example embodiment”, “one or more embodiments”, “some embodiments”, etc., indicate that the embodiment or embodiments described may include a particular feature, structure, or characteristic, but every embodiment may not necessarily include the particular feature, structure, or characteristic. Moreover, such phrases are not necessarily referring to the same embodiment or embodiments. In addition, when a particular feature, structure, or characteristic is described in connection with an embodiment or embodiments, it is submitted that it is within the knowledge of one skilled in the art to affect such feature, structure, or characteristic in connection with other embodiments whether or not explicitly described. After reading the description, it will be apparent to one skilled in the relevant art(s) how to implement the disclosure in alternative embodiments. Thus, it will be appreciated that embodiments of the present disclosure may employ any combination of features described herein. All such combinations or sub-combinations of features are within the scope of the present disclosure.

Throughout this specification, terms of art may be used. These terms are to take on their ordinary meaning in the art from which they come, unless specifically defined herein or the context of their use would clearly suggest otherwise.

The drawings in the FIGURES are not to scale. Similar elements are generally denoted by similar references in the FIGURES. For the purposes of this disclosure, the same or similar elements may bear the same references. Furthermore, the presence of reference numbers or letters in the drawings cannot be considered limiting, even when such numbers or letters are indicated in the claims.

The present application may reference quantities and numbers. Unless specifically stated, such quantities and numbers are not to be considered restrictive, but exemplary of the possible quantities or numbers associated with the present application. Also in this regard, the present application may use the term “plurality” to reference a quantity or number. In this regard, the term “plurality” is meant to be any number that is more than one, for example, two, three, four, five, etc. The terms “about,” “approximately,” “near,” etc., mean plus or minus 5% of the stated value. For the purposes of the present disclosure, the phrase “at least one of A and B” is equivalent to “A and/or B” or vice versa, namely “A” alone, “B” alone or “A and B.”. Similarly, the phrase “at least one of A, B, and C,” for example, means (A), (B), (C), (A and B), (A and C), (B and C), or (A, B, and C), including all further possible permutations when greater than three elements are listed.

The principles, representative embodiments, and modes of operation of the present disclosure have been described in the foregoing description. However, aspects of the present disclosure which are intended to be protected are not to be construed as limited to the particular embodiments disclosed. Further, the embodiments described herein are to be regarded as illustrative rather than restrictive. It will be appreciated that variations and changes may be made by others, and equivalents employed, without departing from the spirit of the present disclosure. Accordingly, it is expressly intended that all such variations, changes, and equivalents fall within the spirit and scope of the present disclosure, as claimed.

1. A method of generating physical channel parameters for wireless channels, wherein the method comprises:
obtaining measurement data based on wireless channel observations;
training a generative model with the measurement data such that the generative model learns statistical properties of physical channel parameters based on the measurement data of the wireless channel observations; and
generating physical channel parameters by using the trained generative model.

2. The method according to claim 1, wherein the wireless channel observations are compressed and/or comprise noise.

3. The method according to claim 1, wherein a specific measurement instrument, related to a specific system configuration, is used for obtaining the measurement data.

4. The method according to claim 1, wherein the measurement data are based on wireless channel observations of different wireless channel realizations.

5. The method according to claim 1, wherein the measurement data comprise digital I/Q data.

6. The method according to claim 1, wherein the physical channel parameters comprise at least one of angle of arrival, path loss, complex path loss, Doppler shifts, delays, or number of paths.

7. The method according to claim 1, wherein the physical channel parameters comprise physically interpretable parameters that characterize a wireless channel realization.

8. The method according to claim 1, wherein the physical channel parameters are used for generating at least one new wireless channel realization.

9. The method according to claim 8, wherein at least one system configuration is selected and applied to the physical channel parameters for generating the at least one new wireless channel realization.

10. The method according to claim 8, wherein new wireless channel coefficients are obtained when generating the at least one new wireless channel realization.

11. The method according to claim 10, wherein the new wireless channel coefficients comprise a plurality of sampled values over at least one of the frequency domain, the time domain, or the spatial domain.

12. The method according to claim 8, wherein the at least one new wireless channel realization is generated without retraining the generative model.

13. The method according to claim 8, wherein the at least one new wireless channel realization is physically consistent.

14. The method according to claim 1, wherein the compressibility of the measurement data with respect to the physical parameter domain is exploited for training the generative model.

15. The method according to claim 1, wherein the generative model is a parametrized statistical model from which the physical channel parameters are generated.

16. The method according to claim 1, wherein the generative model is based on a conditional Gaussian distribution.

17. The method according to claim 1, wherein the generative model is built upon a Gaussian mixture model, a variational autoencoder, or a diffusion model.

18. The method according to claim 1, wherein the generative model parameterizes a compressible representation of a wireless channel in its parameter domain to be a conditional Gaussian distribution with a mean of zero and a diagonal covariance matrix.

19. A method of using the physical channel parameters generated by the method according to claim 1 for providing training data to train machine-learning-based signal processing chains and/or for generating artificial wireless channels for testing devices under test.
